(19) United States
(12) Patent Application Publication
(10) Pub. No.: US 2024/0070211 A1
(43) Pub. Date: Feb. 29, 2024

(54) INFORMATION PROCESSING SYSTEM, METHOD, AND NON-TRANSITORY COMPUTER READABLE MEDIUM

(71) Applicant: FUJIFILM Business Innovation Corp., Tokyo (JP)

(72) Inventor: Yoshihiro FUJIMAKI, Kanagawa (JP)

(73) Assignee: FUJIFILM Business Innovation Corp., Tokyo (JP)

(21) Appl. No.: 18/183,486

(22) Filed: Mar. 14, 2023

(30) Foreign Application Priority Data
Aug. 23, 2022 (JP) 2022-132487

(51) Int. Cl. G06F 16/9535; G06F 16/9538

(52) U.S. Cl. CPC G06F 16/9535; G06F 16/9538

(57) ABSTRACT

An information processing system includes one or more processors configured to: acquire correlation information that is information on correlation between user accounts of a user and use sites that have been previously used by the user and that indicates which account, among the user accounts, was used by the user to use the use sites; and cause a display section to perform display about a connection target site, to which the user provides an instruction to connect, and display based on the correlation information.

### CROSS-REFERENCE TO RELATED APPLICATIONS

This application is based on and claims priority under 35 USC 119 from Japanese Patent Application No. 2022-132487 filed Aug. 23, 2022.

### BACKGROUND

### (i) Technical Field

The present disclosure relates to an information processing system, a method, and a non-transitory computer readable medium.

### (ii) Related Art

Japanese Unexamined Patent Application Publication No. 2020-160623 describes a technique of displaying, on a log-in screen that receives a connection operation to connect to a connection target site, an account for a different site that is usable for connection to the connection target site and presenting, to a user, attribute information that needs to be entered when connecting to the connection target site using the account for the different site.

### SUMMARY

There is a scheme that allows a user to log in to a site using a user account for logging in to a different site. It is conceivable to present user accounts that are usable for log-in to different sites and allow the user to select an account to be used for long-in to the different site. In this case, the user is assisted in selecting an account when logging in to a site if information based on the status of use of the user accounts is displayed.

Aspects of non-limiting embodiments of the present disclosure relate to assisting a user in selecting an account when logging in to a site by displaying information on the status of use of user accounts and sites.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or more processors configured to: acquire correlation information that is information on correlation between user accounts of a user and use sites that have been previously used by the user and that indicates which account, among the user accounts, was used by the user to use the use sites; and cause a display section to perform display about a connection target site, to which the user provides an instruction to connect, and display based on the correlation information.

### BRIEF DESCRIPTION OF THE DRAWINGS

Exemplary embodiments of the present disclosure will be described in detail based on the following figures, wherein:

FIG. 1 illustrates an example of the overall configuration of an information processing system according to a first exemplary embodiment;

FIG. 2 illustrates an example of the configuration of a service providing server, an account management server, and a terminal apparatus according to the first exemplary embodiment;

FIG. 3 illustrates the functional configuration of the terminal apparatus according to the first exemplary embodiment;

FIG. 4 illustrates an example of data about use of sites with user accounts according to the first exemplary embodiment;

FIG. 5 illustrates a different example of data about use of sites with user accounts according to the first exemplary embodiment;

FIG. 6 illustrates a different example of data about use of sites with user accounts according to the first exemplary embodiment;

FIG. 7 illustrates an example of a process in which the terminal apparatus performs display based on correlation information, of a process sequence according to the first exemplary embodiment;

FIG. 8 illustrates an example of a screen that is used to display a suggested account;

FIG. 9 is a flowchart illustrating the flow of a process in which the terminal apparatus specifies a suggested account according to the first exemplary embodiment;

FIGS. 10A to 10C each illustrate an example of information prepared through a suggested account specifying process according to the first exemplary embodiment, in which FIG. 10A illustrates information that specifies identity providers (IdPs) that are usable for log-in to a connection target site, FIG. 10B illustrates information that indicates the number of times of appearance of user accounts that are used for use sites, and FIG. 10C illustrates information that indicates the result of the suggested account specifying process;

FIG. 11 illustrates a different example of a screen that is used to display a suggested account;

FIG. 12 illustrates a different example of a screen that is used to display a suggested account;

FIG. 13 illustrates a different example of data about use of sites with user accounts according to the first exemplary embodiment.

FIG. 14 illustrates a different example of data about use of sites with user accounts according to the first exemplary embodiment.

FIG. 15 illustrates a different example of data about use of sites with user accounts according to the first exemplary embodiment.

FIG. 16 illustrates an example of the overall configuration of an information processing system according to a second exemplary embodiment;

FIG. 17 illustrates an example of a process in which the terminal apparatus performs display based on correlation information and statistical information, of a process sequence according to the second exemplary embodiment; and

FIG. 18 illustrates a different example of a screen that is used to display a suggested account.

### DETAILED DESCRIPTION

Exemplary embodiments of the present disclosure will be described below with reference to the accompanying drawings.

In the present exemplary embodiment, a configuration in which a certain site (hereinafter referred to as a “connection target site”), to which a user provides an instruction to connect, presents the type of accounts, for which the connection target site itself permits log-in, to allow the user to log in using an existing account (hereinafter referred to as a “user account”) of the user is described as an example.

In the following description, sites that have been previously used by the user will be referred to as “use sites”, and a user account suggested for use for log-in to the connection target site will be referred to as a “suggested account”. The use sites that have been previously used by the user and sites that have not been previously used by the user will occasionally be referred to as “sites” in the case where such sites are not differentiated from each other.

### First Exemplary Embodiment

### Information Processing System 1

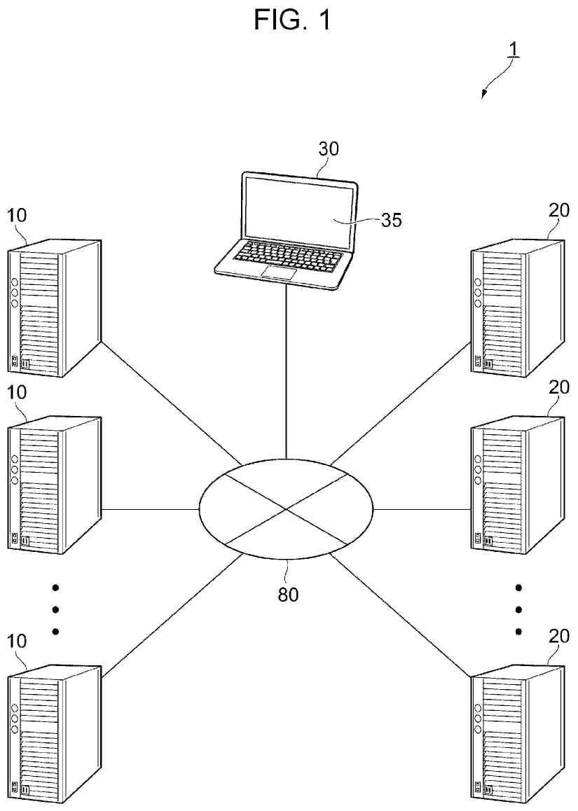

FIG. 1 illustrates an example of the overall configuration of an information processing system 1 according to a first exemplary embodiment.

The information processing system 1 according to the present exemplary embodiment is constituted by connecting service providing servers 10, which constitute sites that provide services to the user, account management servers 20, which manage information on user accounts that are used for log-in to the sites, and a terminal apparatus 30, which receives an instruction to connect to the connection target site from the user, via a communication line 80. The communication line 80 may be a line such as the Internet, for example, and is used for information communication among the service providing servers 10, the account management servers 20, and the terminal apparatus 30.

The service providing server 10 according to the present exemplary embodiment is a server that constitutes a site, to which the user connects from the terminal apparatus 30. The service providing server 10 constitutes a site which is present on the communication line 80 and connectable from the terminal apparatus 30, and which requires the terminal apparatus 30 to log in for connection.

The account management server 20 according to the present exemplary embodiment is a server that stores and manages information on user accounts required to log in to the sites constituted by the service providing servers 10. The account management server 20 is a so-called identity provider (IdP) that provides user authentication information based on a user account to the service providing server 10.

The terminal apparatus 30 according to the present exemplary embodiment is an information terminal apparatus to be connected to the connection target site. The terminal apparatus 30 is provided with a display section 35 composed of a liquid crystal display panel, an organic electro-luminescence (EL) display panel, etc. that displays an image, text information, etc. for the user.

Examples of the terminal apparatus 30 include a personal computer, a tablet terminal, and a smartphone. The terminal apparatus 30 performs information processing etc. according to the present exemplary embodiment by causing various applications to operate under control by an operating system (OS).

The terminal apparatus 30 presents user accounts that are usable for log-in to the connection target site, and receives from the user an operation to provide an instruction for user authentication via the account management servers 20 which manage the user accounts.

The terminal apparatus 30 also performs display about the status of use of user accounts that are usable for log-in to the connection target site.

Specifically, the terminal apparatus 30 performs display for the user on the basis of correlation information on the correlation between user accounts that are usable for log-in to the connection target site and use sites that have been previously used by the user. The “correlation information” is information about use of the user accounts managed by the account management servers 20, and information that indicates which user account, among the user accounts, was used to use the use sites.

An overview of the function of the terminal apparatus 30 of the information processing system 1 according to the present exemplary embodiment will be described.

In the case where an instruction to connect to the connection target site constituted by the service providing server 10 is received from the user, the display section 35 displays on the display section 35 a log-in screen that is a screen about the connection target site and that requests log-in to the connection target site. The terminal apparatus 30 presents user accounts that are usable for the connection target site on the log-in screen, and performs display about the status of use of the presented user accounts.

In other words, the terminal apparatus 30 performs display that presents user accounts that are usable for the connection target site and display based on the correlation information on the presented user accounts.

Since the terminal apparatus 30 according to the present exemplary embodiment has the function discussed above, the user references information based on the status of use of the user accounts at the use sites in the case where the user attempts to log in to the connection target site using the terminal apparatus 30.

### Hardware Configuration

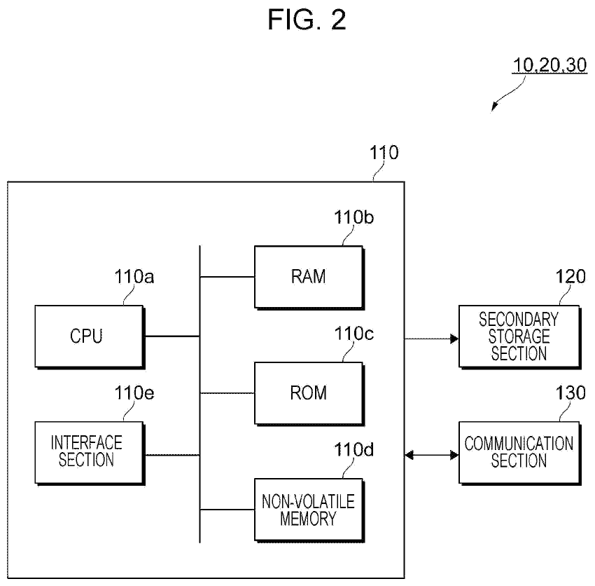

FIG. 2 illustrates an example of the configuration of the service providing server 10, the account management server 20, and the terminal apparatus 30 according to the first exemplary embodiment.

The service providing server 10, the account management server 20, and the terminal apparatus 30 according to the present exemplary embodiment each include a control section 110 that controls operation of the entire device, a secondary storage section 120 that stores information about user accounts etc., and a communication section 130 that transmits and receives information via the communication line 80.

The control section 110, the secondary storage section 120, and the communication section 130 are connected to each other through a bus or a signal line.

The control section 110 includes a central processing unit (CPU) 110a that controls the entire device as an example of a processor, a random access memory (RAM) 110b that is used as a work memory etc. for the CPU 110a, and a read only memory (ROM) 110c that stores a program etc. to be executed by the CPU 110a. The control section 110 also includes a non-volatile memory 110d that is rewritable and that holds data even when power supply is interrupted, and an interface section 110e that controls various sections, such as the communication section 130, connected to the control section 110.

The non-volatile memory 110d is constituted from a static random access memory (SRAM) backed up by a battery, a flash memory, etc., for example. The devices according to the present exemplary embodiment execute processes by the control section 110 reading the program stored in the secondary storage section 120.

The secondary storage section 120 is constituted of a hard disk device (HDD), a semiconductor memory, etc., for example. The secondary storage section 120 is different in accordance with the product form of the devices. The secondary storage section 120 stores information on accounts that are used for log-in, etc., for example. Besides, the secondary storage section 120 stores a program to be executed by the control section 110, information on the sites, etc.

The program to be executed by the CPU 110a as an example of the processor is provided to the control section 110 as stored in a computer-readable storage medium such as a magnetic storage medium (such as a magnetic tape and a magnetic disk), an optical storage medium (such as an optical disc), a magneto-optical storage medium, and a semiconductor memory. Alternatively, the program to be executed by the CPU 110a may be downloaded to the service providing server 10, the account management server 20, and the terminal apparatus 30 using a communication unit such as the Internet.

In the present exemplary embodiment, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

The term “processor” is broad enough to encompass one processor or plural processors in collaboration which are located physically apart from each other but may work cooperatively. The order of operations of the processor is not limited to one described in the present exemplary embodiment, and may be changed.

Besides, the terminal apparatus 30 includes an input device such as a keyboard and a mouse, and the display section 35 (not illustrated in FIG. 2) constituted from a liquid crystal display etc. In the case where the input device is a touch screen, the input device may be provided integrally with the display section 35.

### Service Providing Server 10

The service providing server 10 according to the present exemplary embodiment provides a condition for accounts that are permitted to log in to the sites.

The service providing server 10 permits log-in to the sites with use of accounts of a type determined in advance. In other words, the service providing server 10 permits the user to log in to the sites using the result of an authentication process performed by the account management server 20 determined in advance.

The service providing server 10 receives from the terminal apparatus 30 a request related to information on the log-in screen. The service providing server 10 provides the terminal apparatus 30 which has made a request related to information on the log-in screen with information on the log-in screen, including information that specifies the type of accounts permitted to log in to the sites.

The service providing server 10 also receives user authentication information from the account management server 20. The service providing server 10 permits the user to log in to the sites using a user account that matches the received user authentication information and that is of the type determined in advance.

### Account Management Server 20

The account management server 20 according to the present exemplary embodiment receives a request related to user authentication based on the user account managed by the account management server 20. The account management server 20 executes a process of authenticating the user that attempts to use the user account managed by the account management server 20, and generates user authentication information. The account management server 20 provides the service providing server 10 with the user authentication information to be used for log-in to the sites.

### Terminal Apparatus 30

Next, the functional configuration of the terminal apparatus 30 will be described.

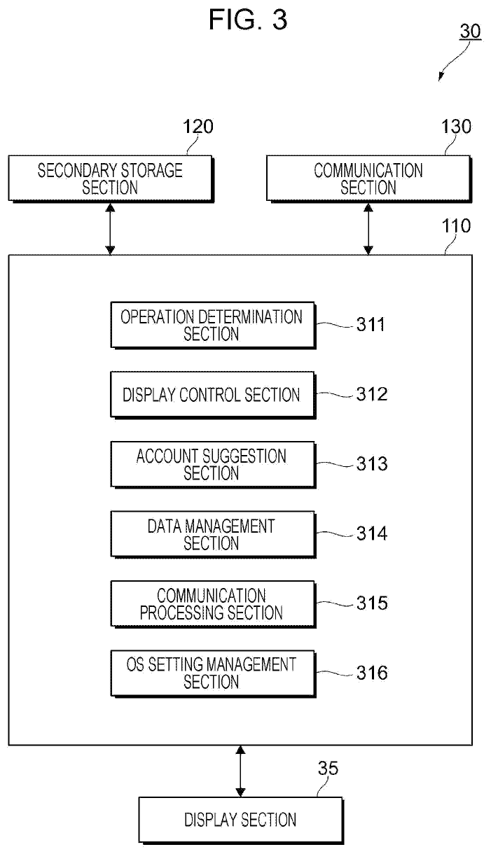

FIG. 3 illustrates the functional configuration of the terminal apparatus 30 according to the first exemplary embodiment. As illustrated in the drawing, the terminal apparatus 30 includes an operation determination section 311, a display control section 312, an account suggestion section 313, a data management section 314, a communication processing section 315, and an OS setting management section 316, which are implemented by the control section 110.

The operation determination section 311 determines whether or not a user operation has been performed on the terminal apparatus 30 via the input device etc. Examples of the user operation include an operation to provide an instruction to connect to the connection target site, an operation to provide an instruction to log in to the connection target site via the account management server 20, etc.

The display control section 312 controls the mode of display on the display section 35 etc.

Specifically, the display control section 312 controls the mode of display of the log-in screen for the connection target site to be displayed on the display section 35. The display control section 312 controls the mode of display of the log-in screen for the connection target site so as to reflect the status of use of user accounts that are usable for the connection target site, for example.

The log-in screen for the connection target site is displayed using a browser etc., for example.

The browser is a program executed by the control section 110, and is a program for connecting to the sites provided by the service providing server 10. The browser allows the user to designate a uniform resource locator (URL) which is an identifier that specifies the connection target site. When the user designates a URL in the browser, the browser connects to the site indicated by the URL to display the log-in screen for the connection target site on the display section 35. The browser may allow the user to add a variety of functions, besides the basic function of displaying the log-in screen for the connection target site. Such functions to be added later are also referred to as “extended functions”, “plug-ins”, “add-ons”, etc.

The account suggestion section 313 specifies a user account suggested for use for log-in to the connection target site. Specifically, the account suggestion section 313 specifies a suggested account from among the user accounts that are usable for log-in to the connection target site. The account suggestion section 313 generates correlation information on the correlation between the user accounts and the use sites that have been previously used by the user, and specifies a suggested account on the basis of the number of use sites correlated with the user accounts, for example.

The data management section 314 manages data about use of the sites with use of the user accounts. In other words, the data management section 314 manages data to be used to generate correlation information.

Examples of the data managed by the data management section 314 include data on the existing user accounts of the user, data on the sites, and data on log-in to the sites by the user.

The data managed by the data management section 314 will be described.

In the following description, the sites constituted by the service providing server 10 provide services named “service A”, “service B”, “service C”, “service D”, and “service E”. A plurality of service providing servers 10 are occasionally differentiated from each other by the names of the services provided by the service providing servers 10. The plurality of account management servers 20 are occasionally referred to as “IdP-A”, “IdP-B”, and “IdP-C, which are IdP names.

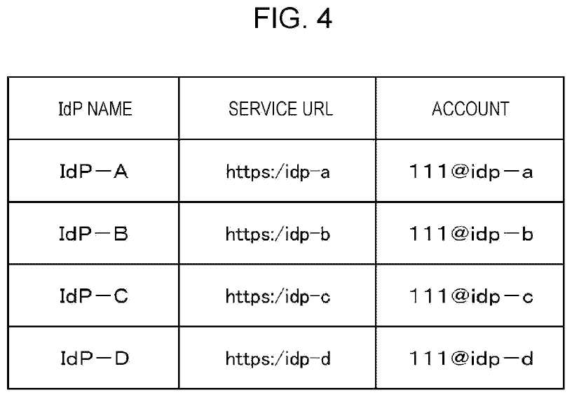

FIG. 4 illustrates an example of data about use of the sites with use of the user accounts according to the first exemplary embodiment, illustrating data on the existing user accounts of the user.

The data on the user accounts include information on the user accounts managed by the account management server 20.

Specifically, the data on the user accounts include information in which the IdP name of the account management server 20, the service URL which is an identifier that specifies the service provided by the account management server 20, and the user account itself are correlated with each other.

In the example illustrated in FIG. 4, “IdP-A”, among the account management servers 20, is correlated with a service URL “https:/idp-a” at which an authentication service is provide and a user account “111@idp-a” for which information such as account name and password is managed, for example.

Besides, “IdP-B”, “IdP-C”, and “IdP-D” are also correlated with a service URL and a managed user account.

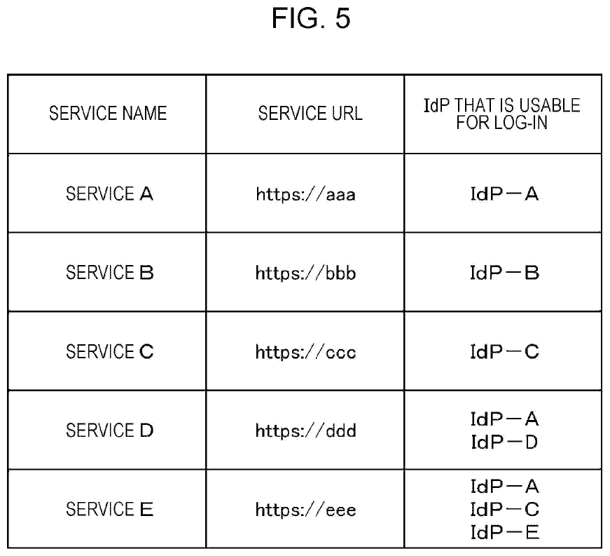

FIG. 5 illustrates a different example of data about use of the sites with use of the user accounts according to the first exemplary embodiment, illustrating data on the sites.

The data on the sites include information on the type of the account management server 20 that is able to provide user authentication information to the site constituted by the service providing server 10.

Specifically, the data on the sites include information in which the service name related to the service providing server 10, the service URL which is an identifier that specifies the service provided at the site, and the IdP name of the account management server 20 that is permitted to be used for log-in to the site are correlated with each other.

In the example illustrated in FIG. 5, “service A”, among the services related to the service providing servers 10, is correlated with a service URL “https://aaa” at which the log-in screen is displayed and an account management server 20 “IdP-A” that is able to handle the user authentication process.

Specifically, it is indicated that “service A” permits the user to log in to the site using the result of the authentication process by “IdP-A”.

Besides, “service B”, “service C”, “service D”, and “service E” are also correlated with a service URL and an account management server 20 that is able to handle the user authentication process.

Two or more account management servers 20 may be set as the account management server 20 that is permitted to be used for log-in to the site, as with “service D” and “service E”.

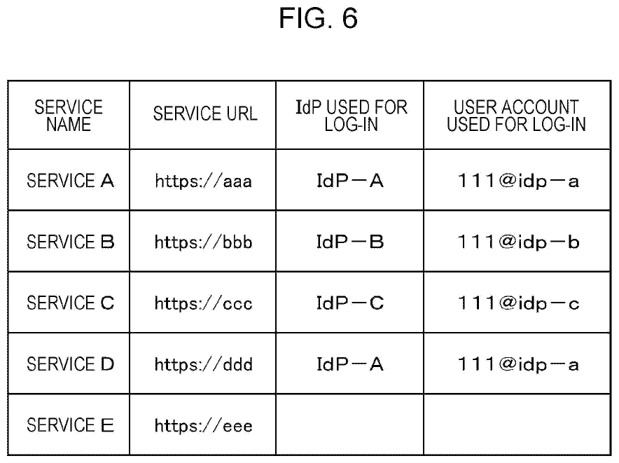

FIG. 6 illustrates a different example of data about use of the sites with use of the user accounts according to the first exemplary embodiment, illustrating data on log-in by the user.

The data on log-in by the user include information on the account management server 20 and the user account which are used when the user logs in to the site. In other words, the data on log-in by the user include a record of use of the account management server 20 and the user account.

Specifically, the data on log-in by the user include information in which the service name related to the service providing server 10, the service URL which specifies the service provided at the site, the account management server 20 that is used for log-in to the site, and the user account itself that is used for log-in to the site are correlated with each other.

In the example illustrated in FIG. 6, “service A”, among the services related to the service providing servers 10, is correlated with a service URL “https://aaa” at which the log-in screen is displayed, an account management server 20 “IdP-A” which handled the user authentication process, and a user account “111@idp-a” which was used for the user authentication process.

Specifically, it is indicated that “service A” was used using the user account “111 @idp-a” authenticated by “IdP-A”.

Besides, “service B”, “service C”, and “service D” are also correlated with a service URL, an account management server 20 that handled the user authentication process, and a user account used for the user authentication process.

“Service E” has not been previously used by the user, and therefore is not correlated with an account management server 20 that handled the user authentication process or a user account that was used for the user authentication process.

The data on log-in by the user are not limited to the above information, and may include the date and time when the user account was used for the use site or a use history of the user account. This allows generation of correlation information that reflects the present status of use of the user account that is usable for the connection target site.

The communication processing section 315 illustrated in FIG. 3 processes information to be transmitted by the communication section 130, and processes received information.

The communication processing section 315 requests the service providing server 10 for information on the log-in screen, and requests the account management server 20 for user authentication based on the user account, via the communication section 130.

The communication processing section 315 also extracts information on the log-in screen from information transmitted from the service providing server 10, and extracts information about the user account from information transmitted from the account management server 20, via the communication section 130. In other words, the communication processing section 315 processes acquired information, and makes a determination.

The OS setting management section 316 manages setting information for various functions implemented by the OS. For example, the OS setting management section 316 manages information on setting for automatic entry of a user account name and a password, setting for network connection under control by the communication processing section 315, etc.

### Process Flow

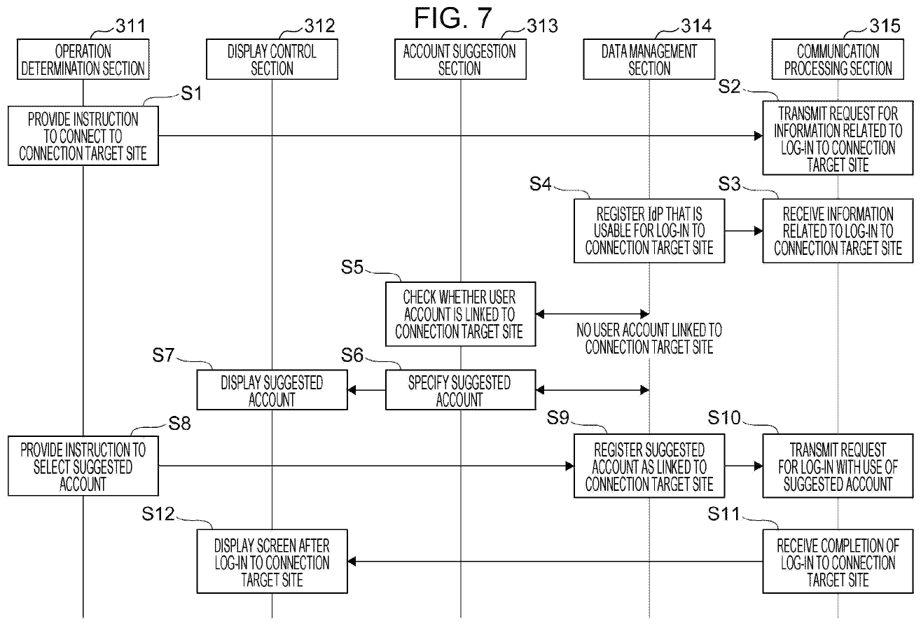

FIG. 7 illustrates an example of a process in which the terminal apparatus 30 performs display based on correlation information, of a process sequence according to the first exemplary embodiment.

As a precondition for this process, the process performed by the terminal apparatus 30 according to the present exemplary embodiment is prepared as a program of dedicated application software (hereinafter referred to as a “suggestion app”) that implements suggestion of a suggested account. This program may be not only provided by a communication unit but also provided as stored in a storage medium such as a compact disk read only memory (CD-ROM).

In the example in FIG. 7, the user provides an instruction to connect to the connection target site on the suggestion app.

First, the operation determination section 311 of the terminal apparatus 30 determines that a user operation has been performed on the suggestion app to provide an instruction to connect to the connection target site (51). The operation determination section 311 determines that a user operation has been performed to provide an instruction to connect to the connection target site in the case where an operation has been performed to select a service URL of the connection target site registered in advance in the suggestion app, for example.

Then, the communication processing section 315 of the terminal apparatus 30 transmits a request for information related to log-in to the connection target site to the service providing server 10 which constitutes the connection target site (S2). The information related to log-in to the connection target site includes information that specifies the type of accounts permitted to log in to the connection target site.

The communication processing section 315 receives information related to log-in to the connection target site from the service providing server 10 which has been requested for information related to log-in to the connection target site (S3).

The data management section 314 of the terminal apparatus 30 registers the IdP name of the account management server 20 that is usable for log-in to the connection target site on the basis of the information acquired by the communication processing section 315 (S4). In other words, the data management section 314 specifies, among the user accounts, a user account that is usable for the connection target site, on the basis of the information acquired by the communication processing section 315, when connected to the connection target site.

In the case where the IdP name of the account management server 20 that is usable for log-in to the connection target site has already been registered, the data management section 314 updates the IdP name on the basis of the information acquired by the communication processing section 315.

Next, the account suggestion section 313 of the terminal apparatus 30 checks whether or not a user account is linked to the connection target site (S5). Specifically, the account suggestion section 313 inquires the data management section 314 to check the presence or absence of a user account correlated with the connection target site on the basis of data on log-in to the site by the user.

In this process example, it is assumed that no user account is linked to the connection target site as with “service E” illustrated in FIG. 6.

The account suggestion section 313 of the terminal apparatus 30 specifies a suggested account on the basis of the correlation information (S6). As discussed in detail later, the account suggestion section 313 specifies a user account linked to the largest number of use sites, among the user accounts that are usable for the connection target site, on the basis of the correlation information generated from the data managed by the data management section 314.

The display control section 312 of the terminal apparatus 30 displays the suggested account specified by the account suggestion section 313 on the display section 35 (S7).

The display of the suggested account will be described.

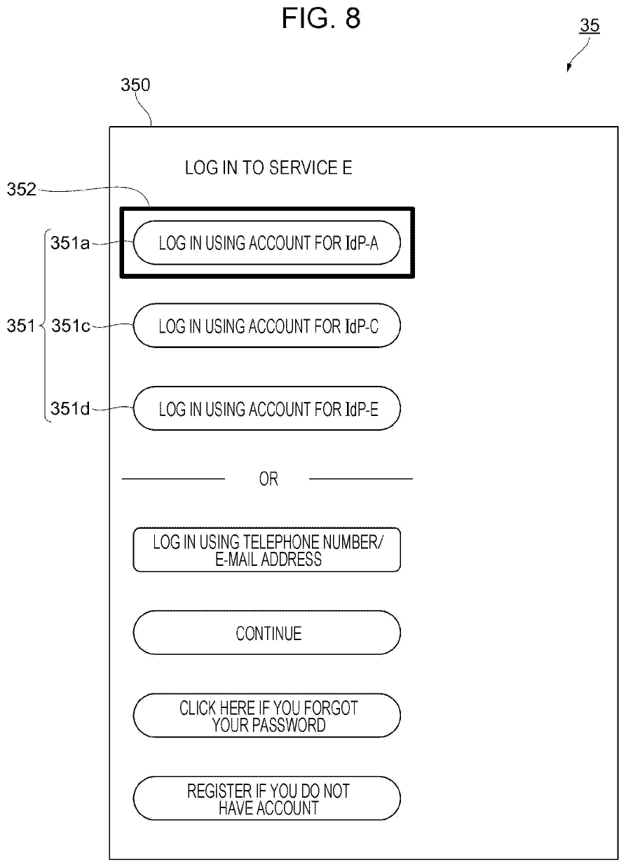

FIG. 8 illustrates an example of a screen that is used to display the suggested account.

In the example in FIG. 8, the connection target site is a site that provides “service E”, and the user has not previously used “service E”.

The display section 35 of the terminal apparatus 30 displays a log-in screen 350 that presents the type of accounts that are usable for log-in to the connection target site.

Specifically, the log-in screen 350 includes button images 351 (351a, 351c, 351d) that receive an instruction to log in to the connection target site from the user.

Besides, the log-in screen 350 may receive, from the user, an instruction to log in to the connection target site using a user account not managed by the account management server 20. The log-in screen may also receive a request to disclose a password required for the user authentication process or a request to reset the password. The log-in screen may also receive registration of a new user account.

In the display example illustrated in FIG. 8, the button images 351 are displayed the account management servers 20 that perform the user authentication process at the time of log-in.

The button images 351 receive, from the user, an instruction to select the account management server 20 that executes the user authentication process in order to log in to the connection target site. In other words, the button images 351 receive an instruction from the user to select a user account to be used for log-in to the connection target site, from among the user accounts managed by the account management servers 20.

The button image 351a receives, from the user, an instruction to log in to the connection target site using a user account managed by “IdP-A”. The button image 351c receives, from the user, an instruction to log in to the connection target site using a user account managed by “IdP-C”. The button image 351d receives, from the user, an instruction to log in to the connection target site using a user account managed by “IdP-E”.

In the display example illustrated in FIG. 8, in which a suggested account is displayed as an example of display based on the correlation information, a highlighting image 352 highlights one of the button images 351 corresponding to the account management server 20 that manages the suggested account, by surrounding the button image 351.

The highlighting image 352 is an image that informs the user of information about the use sites linked to the user accounts. Specifically, the highlighting image 352 is an image that informs the user of the button image 351 specified on the basis of the correlation information.

In this process example, it is assumed that the user receives an instruction to log in to the connection target site using the suggested account.

The operation determination section 311 of the terminal apparatus 30 determines that a user operation has been performed to provide an instruction to select the suggested account (S8). In other words, the operation determination section 311 determines that a user operation has been performed to provide an instruction to log in to the connection target site using the suggested account.

Then, the data management section 314 of the terminal apparatus 30 registers the suggested account as linked to the connection target site (S9). Specifically, the data management section 314 registers the IdP name of the account management server 20 suggested for use for log-in to the connection target site and the user account itself as linked to the connection target site.

The communication processing section 315 of the terminal apparatus 30 transmits a request for log-in with use of the suggested account to the service providing server 10 that constitutes the connection target site and the account management server 20 that manages the suggested account (S10).

Then, the communication processing section 315 receives information related to completion of log-in to the connection target site from the service providing server 10 that has been requested log-in to the connection target site with the suggested account (S11).

In the present exemplary embodiment, an internal browser of the suggestion app is started to open the log-in page for the connection target site in the case where an instruction is provided to log in to the connection target site using the suggested account, although not described above. Information on the suggested account registered in the data management section 314 is automatically entered into the log-in page for the connection target site. Specifically, the IdP name of the account management server 20, the user account name, and the password are automatically entered into the log-in page for the connection target site. Consequently, user authentication is completed with the account management server 20 executing a process of authenticating the user that attempts to use the connection target site constituted by the service providing server 10.

Then, the display control section 312 of the terminal apparatus 30 displays a screen after completion of log-in to the connection target site on the display section 35 (S12). This allows the user to use the connection target site using the suggested account.

### Specification of Suggested Account

A process example for a case where the account suggestion section 313 specifies a suggested account on the basis of the correlation information will be described.

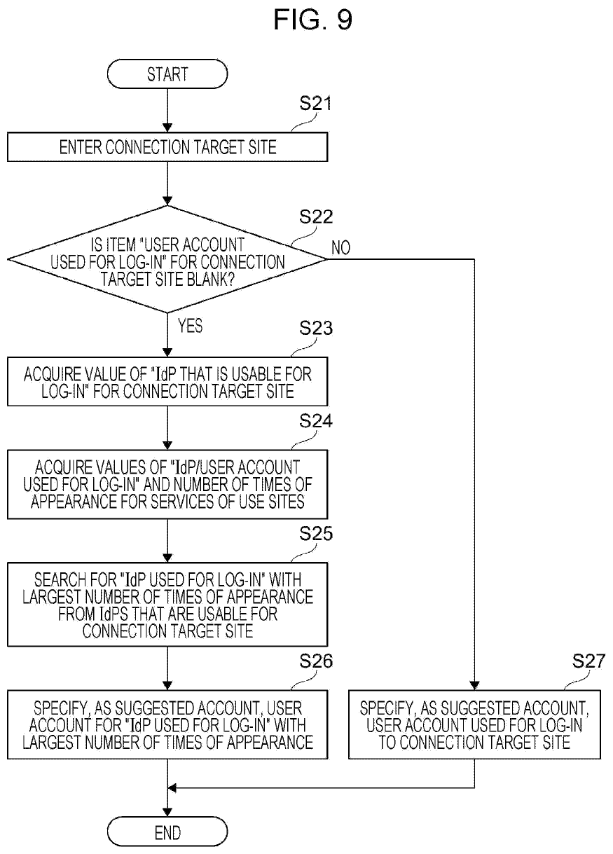

FIG. 9 is a flowchart illustrating the flow of a process in which the terminal apparatus 30 specifies a suggested account according to the first exemplary embodiment.

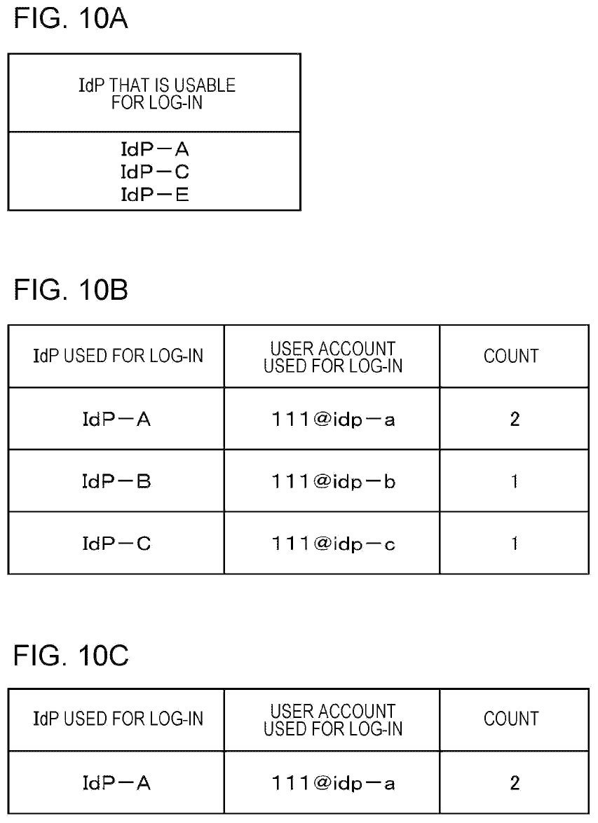

FIGS. 10A to 10C each illustrate an example of information prepared through a suggested account specifying process according to the first exemplary embodiment, in which FIG. 10A illustrates information that specifies IdPs that are usable for log-in to the connection target site, FIG. 10B illustrates information that indicates the number of times of appearance of the user accounts that are used for the use sites, and FIG. 10C illustrates information that indicates the result of the suggested account specifying process.

In the examples in FIGS. 9 and 10A to 10C, the data illustrated in FIGS. 4 to 6 are managed as date about use of the sites with use of the user accounts.

In FIG. 9, first, the account suggestion section 313 enters the service name of a service (hereinafter referred to as a “connection target service”) provided by the connection target site (S21).

The account suggestion section 313 determines, for the service name of the connection target service, whether or not the column for the item “user account used for log-in” included in the data on log-in by the user managed by the data management section 314 is blank (S22).

For example, in the case where the account suggestion section 313 enters a service name “service A”, “111@idp-a” which was used for log-in to the connection target service has already been registered in the column for the item “user account used for log-in” as illustrated in FIG. 6, and therefore it is determined that the column is not blank.

On the other hand, in the case where the account suggestion section 313 enters a service name “service E”, for example, there are no data in the column for the item “user account used for log-in” as illustrated in FIG. 6, and therefore it is determined that the column is blank.

In the case where the column for the item “user account used for log-in” is blank (YES in S22), the account suggestion section 313 acquires, for the service name of the connection target service, a value of the item “IdP that is usable for log-in” included in the data on the sites managed by the data management section 314 (S23).

For example, the account suggestion section 313 acquires information indicating that “IdP-A”, “IdP-C”, and “IdP-E” are usable for log-in to the connection target service “service E”, as in FIG. 10A, on the basis of the data illustrated in FIG. 5.

Then, the account suggestion section 313 acquires, for the services of the use sites that the user has previously used, values of the items “IdP used for log-in” and “user account used for log-in” and the number of times of appearance of such values included in the data on log-in by the user managed by the data management section 314 (S24). Specifically, the account suggestion section 313 acquires values of the items “IdP used for log-in” and “user account used for log-in” correlated with each service name, and counts the number of times of appearance of such values.

For example, the account suggestion section 313 acquires values of the items “IdP used for log-in” and “user account used for log-in” correlated with each service name on the basis of the data illustrated in FIG. 6, and counts the number of times of appearance of such values. Information that indicates the number of use sites linked to the account management server 20 and the user account is acquired, as illustrated in FIG. 10B, as a result of counting the number of times of appearance. Two use sites are linked to the user account managed by “IdP-A”, one use site is linked to the user account managed by “IdP-B”, and one use site is linked to the user account managed by “IdP-C”. An account management server 20 and a user account not linked to any use site are omitted.

Then, the account suggestion section 313 searches for the IdP name of the account management server 20 with the largest number of times of appearance of the value of the item “IdP used for log-in”, from among the account management servers 20 that are usable for the connection target service (S25).

The information acquired through the search by the account suggestion section 313 is an example of the correlation information.

For example, the account suggestion section 313 searches the information illustrated in FIG. 10B for the account management server 20 with the largest value of the item “count” using the IdP name illustrated in FIG. 10A as the key. The account suggestion section 313 compares “IdP-A” and “IdP-C” which are found on the basis of the IdP name, and acquires information indicating that “IdP-A” is the account management server 20 with the largest value of the item “count” as illustrated in FIG. 10C.

Then, the account suggestion section 313 specifies, as the suggested account, a user account managed by the account management server 20 with the largest number of times of appearance of the value of the item “IdP used for log-in” (S26), and ends the process.

For example, the account suggestion section 313 acquires values of the item “user account used for log-in” on the basis of the information illustrated in FIG. 10B, and specifies “111@idp-a” as the suggested account.

Consequently, display based on the number of use sites linked to the user accounts is performed as display of the suggested account. Specifically, the suggested account is displayed by displaying the user account with the largest number of linked use sites and the other user accounts, among the user accounts that are usable for log-in to the connection target site, in different display modes.

For example, the button image 351 corresponding to the account management server 20 for the user account with the largest number of linked use sites, among the button images 351 (FIG. 8), is displayed in association with the highlighting image 352 (see FIG. 8). On the other hand, the button images 351 corresponding to the account management servers 20 for the other user accounts are not displayed with the highlighting image 352.

In the case where the column for the item “user account used for log-in” is not blank in S22 (NO in S22), the account suggestion section 313 specifies the user account used for log-in to the connection target service as the suggested account (S27), and ends the process.

The mode of display of the suggested account may be different between a case where the column for the item “user account used for log-in” is not blank and the column for the item “user account used for log-in” is blank. In other words, in displaying the suggested account, display performed for a user account used for log-in to the connection target service and display performed for user accounts not used for log-in to the connection target service may be different from each other. For example, the highlighting image 352 (see FIG. 8) may be displayed in different modes such as in the solid line or broken line, being flashed on and off or kept on, or in the red color or blue color, or may be shaped differently.

The display of the suggested account according to the first exemplary embodiment is not limited to an image that surrounds the button image 351 (see FIG. 8) corresponding to the suggested account, and may be an image such as an arrow or an image including a text message such as a pop-up image.

In the case of an image including a text message such as a pop-up image, display is performed to inform the user of information about the suggested account.

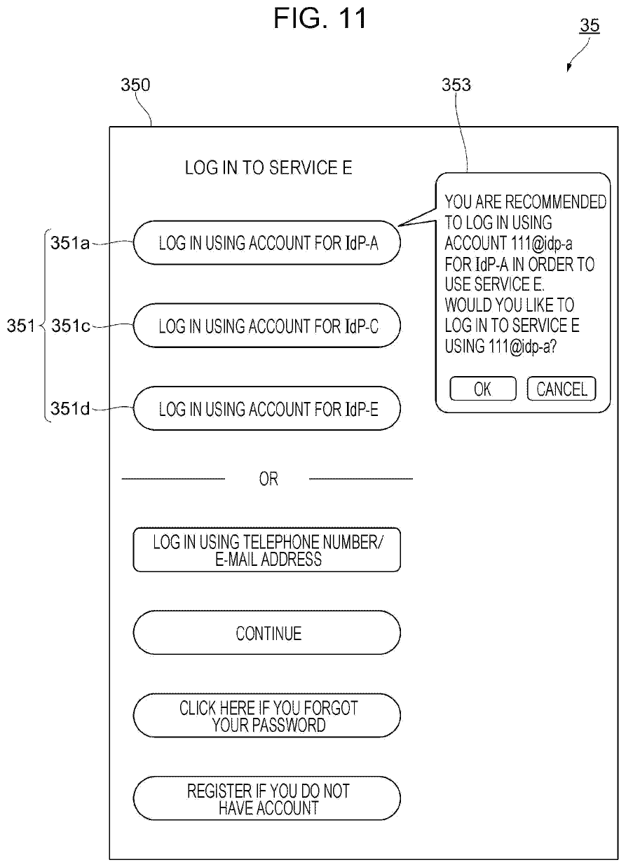

FIG. 11 illustrates a different example of a screen that is used to display the suggested account.

In the example in FIG. 11, a user account managed by the account management server 20 “IdP-A” is specified as the suggested account at the time of log-in to the connection target site which provides “service E”.

In the display example illustrated in FIG. 11, a confirmation image 353 that causes the user to confirm log-in to the connection target site with use of the suggested account is displayed in addition to the button images 351 which receive an instruction to log in to the connection target site from the user.

The confirmation image 353 is an image that informs the user of the user account itself specified as the suggested account. In other words, the confirmation image 353 is an image that informs the user of the user account itself specified on the basis of the correlation information.

An operation by the user to specify whether or not to log in to the connection target site using the user account indicated using a text message may be received in the confirmation image 353.

For example, an “OK” image illustrated in FIG. 11 receives, from the user, an instruction to log in to the connection target site using the suggested account as the user agrees to do so. On the other hand, a “cancel” image receives, from the user, an instruction to hide the confirmation image 353 as the user refuses to log in to the connection target site using the suggested account.

While only the result of the suggested account specifying process is indicated in displaying the suggested account in the process example discussed above, this is not limiting, and the correlation information used to specify the suggested account may also be indicated.

In the case where the correlation information used to specify the suggested account is indicated, display is performed to inform the user of information about the use sites linked to the user accounts that are usable for log-in to the connection target site.

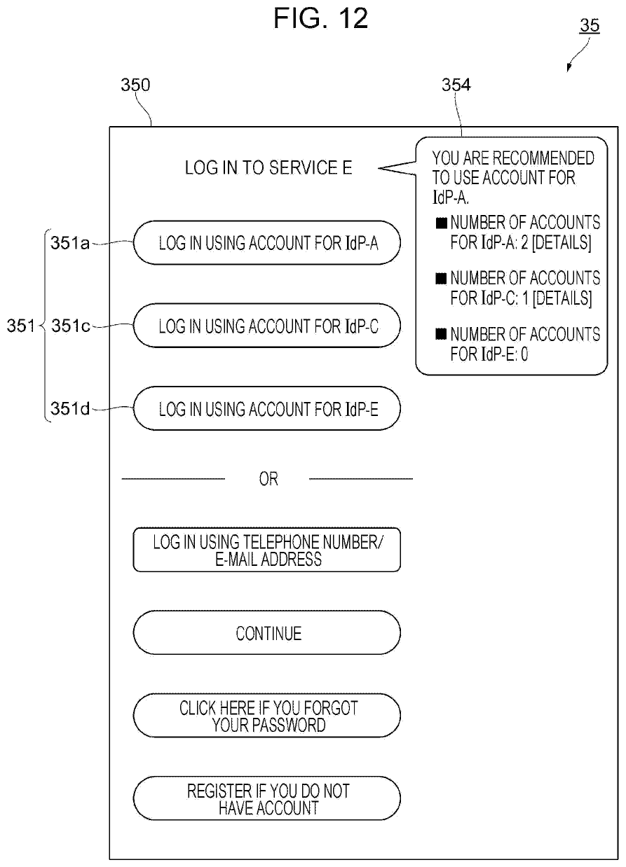

FIG. 12 illustrates a different example of a screen that is used to display the suggested account.

In the example in FIG. 12, a user account managed by the account management server 20 “IdP-A” is specified as the suggested account at the time of log-in to the connection target site which provides the “service E”.

In the display example illustrated in FIG. 12, a reference image 354 to be referenced by the user for the number of use sites linked to the user accounts is displayed in addition to the button images 351 which receive an instruction to log in to the connection target site from the user.

The reference image 354 is an image that informs the user of the details of the number of use sites linked to the user accounts that are usable for log in to the connection target site. In other words, the reference image 354 is an image that informs the user of the details of the correlation information.

The reference image 354 is not limited to being configured to display only the number of use sites linked to the user accounts that are usable for log in to the connection target site. The reference image 354 may display detailed information on the correlation information such as the service name of the use sites linked to the user accounts, the date and time when the user accounts were used for the use sites, and the frequency of use of the user accounts.

For example, detailed information on the correlation information such as that described above may be additionally displayed in the case where an instruction to display detailed information on the correlation information on each user account is received from the user with “[details]” images illustrated in FIG. 12.

The suggested account specifying process by the terminal apparatus 30 according to the first exemplary embodiment may be based on not only the number of use sites correlated with the user accounts but also the attribute of the connection target site for the user.

In this case, in the suggested account specifying process, a suggested account is specified from among user accounts correlated with use sites with an attribute that coincides with the attribute of the connection target site. A process example for a case where the terminal apparatus 30 specifies a suggested account in consideration of the attribute of the connection target site will be described below.

First, data about an attribute that is used to generate correlation information will be described.

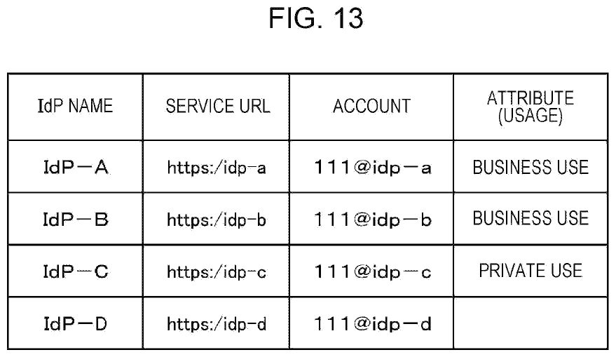

FIG. 13 illustrates a different example of data about use of the sites with use of the user accounts according to the first exemplary embodiment, illustrating data on the attribute of the existing user accounts of the user.

The data illustrated in FIG. 13 are correlated with the attribute of the user accounts, in addition to the data illustrated in FIG. 4.

The attribute of the user account is information that indicates how the user account is used. The attribute of the user account is information that indicates the attribute of the use site with which the user account is correlated, for example. Specifically, the attribute of the user account is “business use” in the case where the user account is used for log-in to a use site with an attribute “business-oriented”. Thus, in the case where a certain user account is used for log-in to a use site with an attribute “business-oriented” and a use site with an attribute “non-business-oriented”, the certain user account is provided with two attributes “business use” and “private use”.

In the example illustrated in FIG. 13, it is indicated that the user account “111@idp-a”, information of which such as account name and password is managed by “IdP-A”, among the account management servers 20, has an attribute “business use”, for example. This is because the user account “111@idp-a” is used for log-in to the service A provided at a use site with an attribute “business-oriented”.

Besides, also for “IdP-B”, it is similarly indicated that the user account has an attribute “business use”. For “IdP-C”, the user account “111@idp-c” managed by “IdP-C” is used for log-in to the service C provided at a use site with an attribute “non-business-oriented”. Therefore, it is indicated that the user account “111@idp-c” has an attribute “private use”. For “IdP-D”, the user account “111@idp-d”, information of which such as account name and password is managed by “IdP-D”, is not used for log-in to any site, and the usage of the user account is not registered.

The attribute of the user account may be specified and registered in accordance with a condition determined in advance, or may be registered in accordance with an input from the user, irrespective of the attribute of the use site, to which the user account is used for log-in.

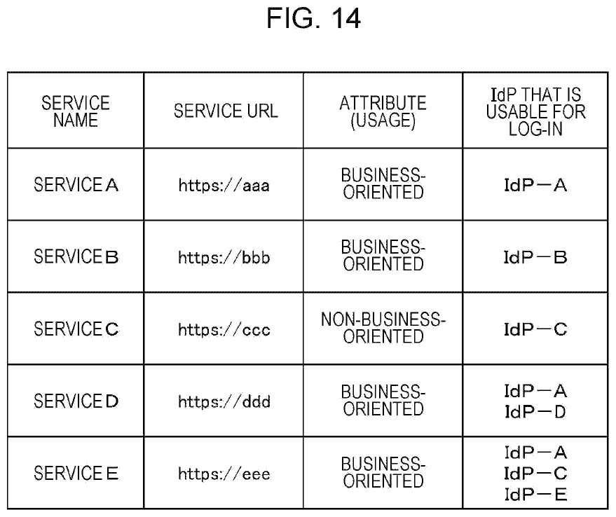

FIG. 14 illustrates a different example of data about use of the sites with use of the user accounts according to the first exemplary embodiment, illustrating data on the attribute of the sites.

The data illustrated in FIG. 14 are correlated with the attribute of the sites, in addition to the data illustrated in FIG. 5.

The attribute of the site is information that indicates how the site is used. Examples of the information that indicates how the site is used include the type of the service provided by the site, the usage of the site, the time period for which the site is used, etc.

The attribute of the site may be specified and registered in accordance with a condition determined in advance, or may registered in accordance with an input from the user.

In the example illustrated in FIG. 14, it is indicated that “service A”, among the services related to the service providing servers 10, has an attribute “business-oriented”, for example.

Besides, the attribute of the site is also indicated for “service B”, “service C”, “service D”, and “service E”.

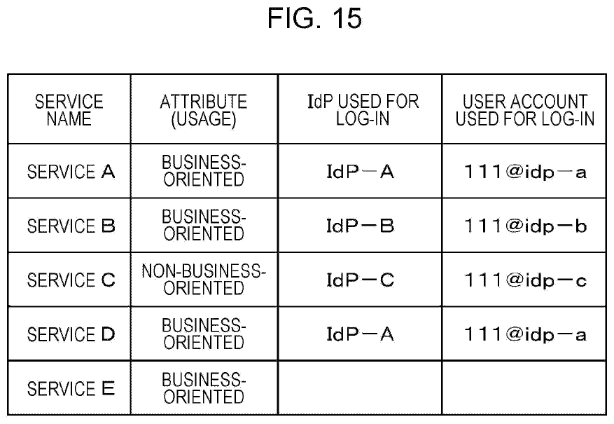

FIG. 15 illustrates another example of data about use of the sites with use of the user accounts according to the first exemplary embodiment, illustrating data on log-in by the user.

The data illustrated in FIG. 15 are correlated with the attribute of the sites, in addition to the data illustrated in FIG. 6.

In the example illustrated in FIG. 15, “service E” with an attribute “business-oriented” has not been previously used by the user, and therefore the account management server 20 which handled the user authentication process and the user account which was used for the user authentication process are not correlated with each other.

The account suggestion section 313 generates correlation information on the correlation between the user accounts and the use sites previously used by the user on the basis of the data illustrated in FIGS. 13 to 15. Then, the account suggestion section 313 specifies, as the suggested account, a user account that matches the attribute of the connection target site from among the user accounts that are usable for log-in to the connection target site. Specifically, in the case where the attribute of the connection target site and the attribute of a use site coincide with each other, the account suggestion section 313 specifies, as the suggested account, a user account that was used for log-in to the use site.

Specifically, at the time of log-in to the connection target site which provides “service E” with an attribute “business-oriented”, “111 @idp-a” which is linked to the largest number of use sites is specified as the suggested account, from among user accounts with an attribute “business use”. In other words, at the time of log-in to the connection target site which provides “service E” with an attribute “business-oriented”, “111@idp-a” which is linked to the largest number of use sites is specified as the suggested account, from among user accounts that are used for log-in to use sites with an attribute “business-oriented”.

At the time of log-in to the connection target site which provides a service with an attribute “non-business-oriented”, a user account linked to the largest number of use sites is specified as the suggested account, from among user accounts with an attribute “private use”.

In this process example, display that causes the user to recognize a user account linked to a use site with an attribute that coincides with the attribute of the connection target site is performed as display of the suggested account. Specifically, display that causes the user to recognize a user account linked to a use site with a usage that coincides with the usage of the connection target site is performed. For example, display in which a button image 351 (see FIG. 12) corresponding to a user account linked to a use site with a usage that coincides with the usage of the connection target site is highlighted is performed.

In the case where a plurality of use sites have an attribute that coincides with the attribute of the connection target site, the mode of display of the suggested account may be changed in accordance with the number of use sites linked to the user account. For example, display of a user account linked to the largest number of use sites with an attribute that coincides with the attribute of the connection target site and display of the other accounts, among user accounts linked to a plurality of use sites, may be performed in different display modes.

### Second Exemplary Embodiment

### Information Processing System 2

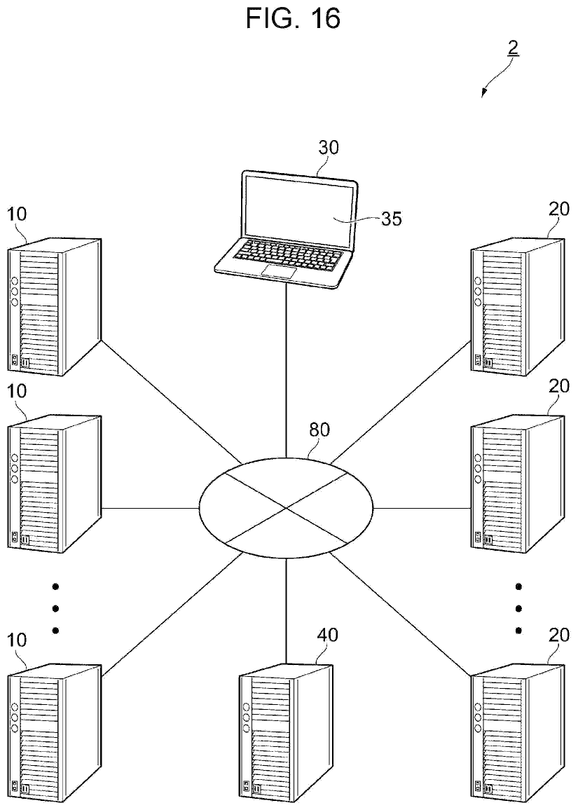

FIG. 16 illustrates an example of the overall configuration of an information processing system 2 according to a second exemplary embodiment.

The information processing system 2 according to the second exemplary embodiment is different from the information processing system 1 according to the first exemplary embodiment in performing display about the status of use of accounts by other users when displaying a suggested account. Differences from the first exemplary embodiment will be described below. Components according to the second exemplary embodiment that are the same as those according to the first exemplary embodiment are denoted by the same reference numerals to omit detailed description thereof.

The information processing system 2 is constituted by connecting service providing servers 10, which constitute sites that provide services to the user, account management servers 20, which manage information on user accounts that are used for log-in to the sites, a terminal apparatus 30, which receives an instruction to connect to the connection target site from the user, and an aggregation server 40, which aggregates information that indicates the status of use of accounts for a certain site, via a communication line 80.

In the present exemplary embodiment, the terminal apparatus 30 shares information on the account management servers 20 that manage accounts linked to the certain site with other users via the aggregation server 40.

The terminal apparatus 30 provides the aggregation server 40 with information on the account management server 20 that is used for log-in to a site in the case where the user logs in to the site.

The terminal apparatus 30 performs display based on information that indicates the status of use by other users acquired from the aggregation server 40 in the case where a suggested account is displayed. Specifically, the terminal apparatus 30 acquires statistical information that indicates statistics on accounts used for the connection target site by other users, and presents user accounts that are usable for log-in to the connection target site and performs display based on the correlation information and the statistical information.

The aggregation server 40 according to the present exemplary embodiment is a server that aggregates information that indicates the status of use of accounts for a certain site and that generates statistical information. The hardware configuration of the aggregation server 40 may be the same as the hardware configuration illustrated in FIG. 2, for example.

The control section 110 of the aggregation server 40 generates, for each account management server 20, statistical information that indicates the number of accounts used for a certain site on the basis of information that indicates the account management servers 20 that have executed user authentication to use the certain site. The control section 110 of the aggregation server 40 may generate, for each account management server 20, statistical information that indicates the number or proportion of users that use an account managed by the account management server 20 for a certain site.

The communication section 130 of the aggregation server 40 receives, from the terminal apparatus 30, information that indicates the account management server 20 that has executed user authentication to use a certain site. The communication section 130 of the aggregation server 40 transmits the generated statistical information to the terminal apparatus 30.

### Process Flow

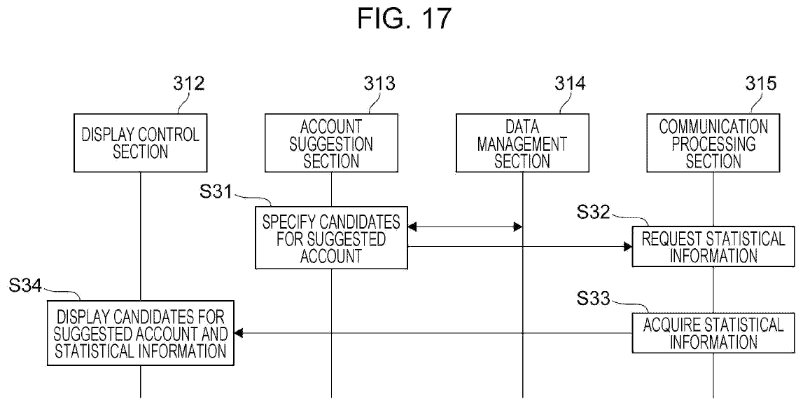

FIG. 17 illustrates an example of a process in which the terminal apparatus 30 performs display based on correlation information and statistical information, of a process sequence according to the second exemplary embodiment.

As a precondition for this process, a suggestion app that implements presentation of a suggested account is used to provide an instruction to connect to the connection target site to acquire the IdP name of the account management server 20 that is usable for the connection target site.

In the example in FIG. 17, a suggested account is not specified with only information on the status of use by users, and statistical information is required.

First, the account suggestion section 313 of the terminal apparatus 30 specifies candidates for the suggested account on the basis of the correlation information (S31).

Specifically, the account suggestion section 313 specifies a plurality of user accounts linked to the largest number of use sites, from among the user accounts that are usable for the connection target site, on the basis of the correlation information generated from the data managed by the data management section 314.

Then, the communication processing section 315 of the terminal apparatus 30 transmits a request for statistical information about the connection target site to the aggregation server 40 which generates the statistical information (S32). The statistical information about the connection target site is information that includes the status of use by other users. The statistical information about the connection target site may be information that includes the status of use by other users for the account management servers 20 that manage the user accounts specified as the candidates for the suggested account.

The communication processing section 315 of the terminal apparatus 30 receives and acquires statistical information about the connection target site from the aggregation server 40 which has been requested for statistical information about the connection target site (S33).

The display control section 312 of the terminal apparatus 30 displays, on the display section 35, the candidates for the suggested account specified by the account suggestion section 313 and the statistical information about the connection target site received from the aggregation server 40 (S34).

The display of the suggested account based on the correlation information and the statistical information will be described.

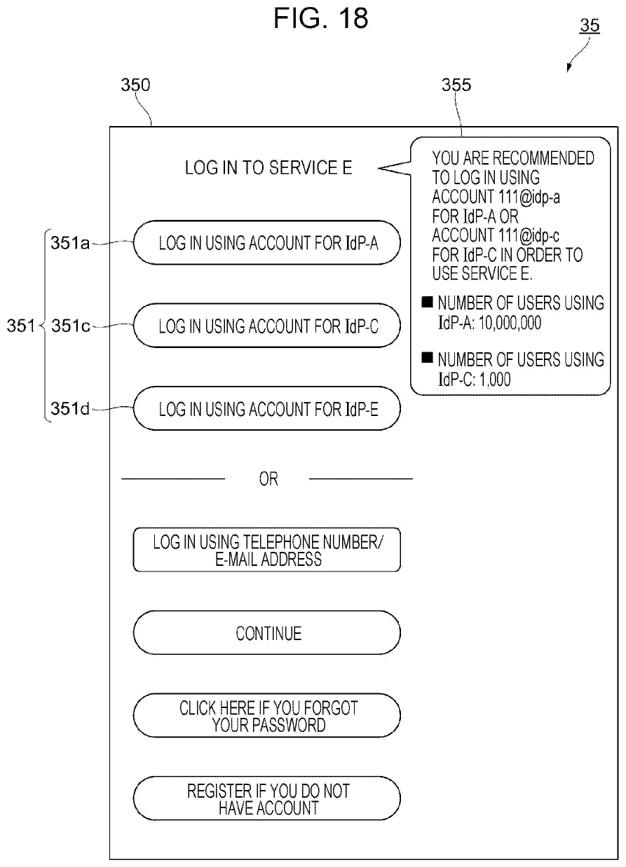

FIG. 18 illustrates a different example of a screen that is used to display the suggested account.

In the example in FIG. 18, the same number of use sites are linked to the user account managed by “IdP-A” and the user account managed by “IdP-C”, among the user accounts that are usable for log-in to the connection target site which provides “service E”.

In the display example illustrated in FIG. 18, a notification image 355 that notifies the user of statistical information on the other users that have used the connection target site is displayed in addition to the button images 351 which receive an instruction to log in to the connection target site from the user.

The notification image 355 is an image that informs the user of a plurality of user accounts themselves specified as candidates for the suggested account and the statistical information about the connection target site. In other words, the notification image 355 is an image that informs the user of user accounts specified on the basis of the correlation information and the number of other users that have used the accounts managed by the account management server 20 for the connection target site.

The notification image 355 is not limited to being configured to indicate, for each account management server 20, the number of other users that have used an account managed by the account management server 20 for the connection target site. The notification image 355 may indicate, for each account management server 20, the proportion of other users that have used an account managed by the account management server 20 for the connection target site.

Besides, the notification image 355 may indicate statistical information about the connection target site also in the case where there is a single user account specified as a candidate for the suggested account.

### Modifications

While display that indicates the suggested account is performed on the log-in screen 350 (see FIG. 12) in the case where the user has provided an instruction to connect to the connection target site that has not been previously used by the user in the example discussed above, this is not limiting. For example, display that indicates the suggested account may be performed also in the case where the user changes the user account to be used for the connection target site after logging in to the connection target site.

The display that indicates the suggested account may include any combination of the highlighting image 352, the confirmation image 353, the reference image 354, and the notification image 355.

While it is necessary for the user to provide an instruction to connect to the connection target site on the suggestion app in the example discussed above, this is not limiting. The suggested account etc. may be provided also in the case where an instruction to connect to the connection target site is provided not via the suggestion app.

For example, the suggested account specifying process may be implemented as a function of the OS of the terminal apparatus 30.

In this case, in the suggested account specifying process, the automatic password entry function, among the functions of the OS of the terminal apparatus 30, is customized such that a user account is specified on the basis of the correlation information and a user account name, a password, etc. are automatically entered.

Specifically, at least the functions of the account suggestion section 313 and the data management section 314 are implemented as the functions of the OS of the terminal apparatus 30. The browser corresponds to a browser of application software that provides a variety of functions.

Besides, the suggested account specifying process may be implemented by the terminal apparatus 30 as a function of a browser that allows browsing a site on the Internet etc., for example.

In this case, in the suggested account specifying process, the browser of the terminal apparatus 30 is additionally provided with a function of executing the suggested account specifying process using a customizing function such as a plug-in or an extended function.

Specifically, the browser of the terminal apparatus 30 is set so as to be additionally provided with at least the functions of the account suggestion section 313 and the data management section 314, besides the basic function of displaying the connection target site.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising
one or more processors configured to:
   acquire correlation information that is information on correlation between user accounts of a user and use sites that have been previously used by the user and that indicates which account, among the user accounts, was used by the user to use the use sites; and
cause a display section to perform display about a connection target site, to which the user provides an instruction to connect, and display based on the correlation information.
   (((2)))

The information processing system according to (((1))),
wherein the one or more processors are configured to:
   specify, among the user accounts, an account that is usable for the connection target site; and
   cause the display section to perform display that presents the usable account, as the display about the connection target site, and the display based on the correlation information.
      (((3)))

The information processing system according to (((2))),
wherein the one or more processors are configured to specify, among the user accounts, the account that is usable for the connection target site when connected to the connection target site.
   (((4)))

The information processing system according to (((2))) or (((3))),
wherein the one or more processors are configured to cause the display section to perform display of the usable account based on the correlation information in a case where the display that presents the usable account is performed.
   (((5)))

The information processing system according to any one of (((1))) to (((4))),
wherein the one or more processors are configured to cause the display section to perform, as the display based on the correlation information, display of the user account correlated with the connection target site and display of the user accounts not correlated with the connection target site in different display modes.
   (((6)))

The information processing system according to any one of (((1))) to (((5))),
wherein the one or more processors are configured to cause the display section to perform, as the display based on the correlation information, display that informs the user of information about the use sites correlated with the user accounts.
   (((7)))

The information processing system according to (((6))),
wherein the one or more processors are configured to cause the display section to perform, as the display that informs the user, display based on a number of the use sites correlated with the user accounts.
   (((8)))

The information processing system according to (((7))),
wherein the one or more processors are configured to cause the display section to perform, as the display based on the number of the use sites, display of an account correlated with a largest number of the use sites and display of other accounts, among the user accounts, in different display modes.
   (((9)))

The information processing system according to (((7))) or (((8))),
wherein the one or more processors are configured to cause the display section to perform, as the display based on the number of the use sites, display that indicates a number of the use sites correlated with each account that is usable for the connection target site, among the user accounts.
   (((10)))

The information processing system according to any one of (((1))) to (((9))),
wherein the one or more processors are configured to:
   acquire information on an attribute of the connection target site; and
   in a case where the use site has an attribute that coincides with the attribute of the connection target site, cause the display section to perform, as the display based on the correlation information, display that allows the user to recognize the user account correlated with the use site with the attribute.
      (((11)))

The information processing system according to (((10))),
wherein the one or more processors are configured to cause, in a case where a plurality of the use sites have an attribute that coincides with the attribute of the connection target site, the display section to perform, as the display that allows the user to recognize the user account, display of an account correlated with a largest number of the use sites with the attribute and display of other accounts, among the user accounts, in different display modes.
   (((12)))

The information processing system according to any one of (((1))) to (((11))),
wherein the one or more processors are configured to:
   acquire statistical information that indicates statistics on accounts used for the connection target site by other users different from the user; and
   cause the display section to perform display about the connection target site and display based on the correlation information and the statistical information.
      (((13)))

A program causing a computer to execute a process comprising:
acquiring correlation information that is information on correlation between user accounts of a user and use sites that have been previously used by the user and that indicates which account, among the user accounts, was used by the user to use the use sites; and
causing a display section to perform display about a connection target site, to which the user provides an instruction to connect, and display based on the correlation information.

What is claimed is:

1. An information processing system comprising
one or more processors configured to:
acquire correlation information that is information on correlation between user accounts of a user and use sites that have been previously used by the user and that indicates which account, among the user accounts, was used by the user to use the use sites; and
cause a display section to perform display about a connection target site, to which the user provides an instruction to connect, and display based on the correlation information.

2. The information processing system according to claim 1,
wherein the one or more processors are configured to:
specify, among the user accounts, an account that is usable for the connection target site; and
cause the display section to perform display that presents the usable account, as the display about the connection target site, and the display based on the correlation information.

3. The information processing system according to claim 2,
wherein the one or more processors are configured to specify, among the user accounts, the account that is usable for the connection target site when connected to the connection target site.

4. The information processing system according to claim 2,
wherein the one or more processors are configured to cause the display section to perform display of the usable account based on the correlation information in a case where the display that presents the usable account is performed.

5. The information processing system according to claim 1,
wherein the one or more processors are configured to cause the display section to perform, as the display based on the correlation information, display of the user account correlated with the connection target site and display of the user accounts not correlated with the connection target site in different display modes.

6. The information processing system according to claim 1,
wherein the one or more processors are configured to cause the display section to perform, as the display based on the correlation information, display that informs the user of information about the use sites correlated with the user accounts.

7. The information processing system according to claim 6,
wherein the one or more processors are configured to cause the display section to perform, as the display that informs the user, display based on a number of the use sites correlated with the user accounts.

8. The information processing system according to claim 7,
wherein the one or more processors are configured to cause the display section to perform, as the display based on the number of the use sites, display of an account correlated with a largest number of the use sites and display of other accounts, among the user accounts, in different display modes.

9. The information processing system according to claim 7,
wherein the one or more processors are configured to cause the display section to perform, as the display based on the number of the use sites, display that indicates a number of the use sites correlated with each account that is usable for the connection target site, among the user accounts.

10. The information processing system according to claim 1,
wherein the one or more processors are configured to:
acquire information on an attribute of the connection target site; and
in a case where the use site has an attribute that coincides with the attribute of the connection target site, cause the display section to perform, as the display based on the correlation information, display that allows the user to recognize the user account correlated with the use site with the attribute.

11. The information processing system according to claim 10,
wherein the one or more processors are configured to cause, in a case where a plurality of the use sites have an attribute that coincides with the attribute of the connection target site, the display section to perform, as the display that allows the user to recognize the user account, display of an account correlated with a largest number of the use sites with the attribute and display of other accounts, among the user accounts, in different display modes.

12. The information processing system according to claim 1,
wherein the one or more processors are configured to:
acquire statistical information that indicates statistics on accounts used for the connection target site by other users different from the user; and
cause the display section to perform display about the connection target site and display based on the correlation information and the statistical information.

13. A method comprising:
acquiring correlation information that is information on correlation between user accounts of a user and use sites that have been previously used by the user and that indicates which account, among the user accounts, was used by the user to use the use sites; and
causing a display section to perform display about a connection target site, to which the user provides an instruction to connect, and display based on the correlation information.

14. A non-transitory computer readable medium storing a program causing a computer to execute a process comprising:
acquiring correlation information that is information on correlation between user accounts of a user and use sites that have been previously used by the user and that indicates which account, among the user accounts, was used by the user to use the use sites; and
causing a display section to perform display about a connection target site, to which the user provides an instruction to connect, and display based on the correlation information.
